(19) United States
(12) Patent Application Publication
(10) Pub. No.: US 2015/0151519 A1
(43) Pub. Date: Jun. 4, 2015

(54) Automotive Component Having a Film Surface and Method for Producing Said Automotive Component

(71) Applicant: Bayerische Motoren Werke Aktiengesellschaft, Muenchen (DE)

(72) Inventors: Peter SIEMSEN, Haar (DE); Manuel SCHWARZ, Landshut (DE); Josef HUBER-HESSELBERGER, Muenchen (DE)

(21) Appl. No.: 14/616,791

(22) Filed: Feb. 9, 2015

Related U.S. Application Data
(63) Continuation of application No. PCT/EP2013/065926, filed on Jul. 29, 2013.

(30) Foreign Application Priority Data
Aug. 16, 2012 (DE) 10 2012 214 562.1

(51) Int. Cl. B32B 27/08; B32B 37/24; B32B 38/00; B32B 27/36; B32B 27/20; B32B 27/30; B32B 27/40; B32B 27/32; B32B 7/12; B32B 37/12; B32B 27/28

(52) U.S. Cl. CPC B32B 27/08; B32B 37/12; B32B 37/24; B32B 38/0008; B32B 27/365; B32B 27/36; B32B 27/286; B32B 27/308; B32B 27/40; B32B 27/32; B32B 27/322; B32B 7/12; B32B 27/20; B32B 2037/243; B32B 2038/0076; B32B 2250/03; B32B 2305/77; B32B 2307/41; B32B 2307/412; B32B 2307/414; B32B 2310/0831; B32B 2605/00

(57) ABSTRACT

A vehicle component, especially for the outer skin of a motor vehicle, includes an unpainted shaping support structure and a film. The film is fastened to at least one surface of the support structure by an adhesive and the film is thermoformable.

### CROSS REFERENCE TO RELATED APPLICATIONS

This application is a continuation of PCT International Application No. PCT/EP2013/065926, filed Jul. 29, 2013, which claims priority under 35 U.S.C. §119 from German Patent Application No. 10 2012 214 562.1, filed Aug. 16, 2012, the entire disclosures of which are herein expressly incorporated by reference.

### BACKGROUND AND SUMMARY OF THE INVENTION

The invention relates to a vehicle component, especially for the outer skin of a motor vehicle, having an unpainted shaping support structure and a film, the film being fastened by an adhesive to at least one surface of the support structure.

Automotive components, which are mounted in the exterior area of vehicles, are generally painted in order to create an attractive visible surface. Fiber-reinforced vehicle components, such as roof elements made of carbon-fiber-reinforced plastic for sports cars, are also coated with a transparent paint in order to produce a surface that is as smooth as possible and to ensure the visibility of the carbon fiber structure situated below it.

Furthermore, coating methods are known from the state of the art, in which a film is applied to the outer skin of the vehicle. The coating of entire vehicles is used for the purpose of individualization, for which mat colors are frequently selected as the surface. In addition, the function of municipal vehicles, for example, for the police, the fire department or other special vehicles, is marked by glued-on film. Usually, the film is applied here manually by means of applicators to the outer skin of the vehicle. The value or the stability of the value of these films is, however, not designed for the service life of the entire vehicle and can also not cover it. As a result of the applicator process, only film types can be processed which easily follow the surface contour. These adaptable film types follow the course of the contours of the components situated underneath and copy them visibly to the outside with a high attention to detail. However, a processing of these films at an increased temperature for improving the adaptability of stiffer film, has the disadvantage that applicator tracks become apparent on the surface. Films with an already cross-linked surface, which have a particularly high stability of value, cannot be applied to vehicle components.

Furthermore, the films that can be applied by an applicator do not reach the required quality standard of paint. In addition, such films are locally damaged by environmental influences, for example, in the form of cracks or color changes. Starting from these cracks, the film will then detach in large areas from the component situated underneath, so that the component is exposed or the original paint becomes visible.

It is therefore an object of the invention to provide a vehicle component as well as a method for producing a vehicle component of the above-mentioned type which meets the requirement with respect to value and stability of value as well as the high qualitative demands with respect to the surface.

This and other objects are achieved according to the invention by providing a vehicle component, especially for the outer skin of an automotive vehicle, having an unpainted shaping support structure and a film. The film is fastened by an adhesive to at least one surface of the support structure. In this case, the film may be thermoformable. Thermoformable films, which are used according to the invention, are distinguished by good deformation characteristics when they are heated and simultaneously exhibit a high resistance to damage. Such films are resistant to contaminations by resin, bird excrement, chemicals as well as to mechanical stress in the form of scratches. By the use of thermoformable films, the softening point of the outermost layer of the outer skin component is shifted upward, so that these components are particularly stable with respect to the development of heat. When solar radiation is strong, this film has the advantage over films known from the prior art that no softening takes place and therefore no surface changes are detectable. Not least, the film has the advantage that a Class A surface can be achieved, which is required in current vehicle construction and so far generally has been produced by layers of paint.

Furthermore, the film may be constructed in several layers, with one support layer and one coating.

In this case, the support layer may, at least in sections, be designed to be transparent, translucent and/or opaque. Such films permit design variations which can only be exhibited at the greatest possible expenditure by means of painting. This film therefore has the advantage that the expenditures for the production of a vehicle component are reduced. Furthermore, multicolored vehicle components can therefore be achieved, for example, having imprints or name structures, in a particularly simple manner.

The support layer can therefore be constructed, in particular, at least of polycarbonate, a polycarbonate blend, polycarbonate copolymer, polyethylene terephthalate, polyethersulfone, acrylic ester styrol acrylonitrile (ASA), an acrylic ester styrol acrylonitrile blend, thermoplastic polyurethane (TPU), polyolefin, polymethylmethacrylate (PMMA), polyvinylidenefluoride (PVDF) and/or a combination thereof.

Particularly an aliphatic polyurethane is suitable as material for the coating. Furthermore, the coating may also comprise additives which protect the coating against aging. In addition, UV absorbers, such as Tinuvin, can also be provided in the coating. Furthermore, the coating may be cross-linkable by means of short-wave radiation, particularly UV light. This has the advantage that the thermoformable film has good forming characteristics during the forming or during the application to the support structure and, after the cross-linking, offers sufficient hardness on the surface of the component.

Furthermore, the support structure of the vehicle component may be constructed of glass- or carbon-fiber-reinforced plastic. However, the invention can also be used for vehicle components where the support structure is constructed of a metallic material, particularly iron plates or aluminum sheets. Naturally, the support structure may also consist of other fiber-reinforced plastics, the fibers being formed of basalt, aramid, or being natural fibers, such as hemp. In addition, a lightweight honeycomb structure may also be used as the support structure.

In a further aspect, the invention relates to a method for producing a vehicle component of the above-described type, with the steps of producing a support structure, applying a thermoformed film to at least one surface of the support structure, the film being constructed of several layers and comprising a support layer and a coating, and gluing the film to the support structure. In addition, the method may include a manufacturing step, during which, after applying the film to the support structure, the coating of the film is cross-linked. As mentioned above, the coating of the support structure with a multilayer film in the thermoforming process with a subsequent cross-linking of the surface offers the advantage that the required long-term use characteristics, such as scratch resistance and durability with respect to environmental influences, can be ensured. Thermoforming and gluing the film to the support structure may preferably take place simultaneously.

Furthermore, the cross-linking of the coating can be implemented by way of short wave radiation. In particular, the coating is acted upon by UV light.

In addition, the film may be thermoformed just before the application to the support structure.

In a first embodiment of the invention, a film is produced which is changed into its final exterior geometric shape by way of a thermoforming process. Subsequently, the formed film is glued onto the support structure. As a a result, small components, such as particularly mirror housings, may be provided with a film.

In a second embodiment of the method, the thermoformable film is produced first and will be thermoformed during the gluing to the support structure.

When produced, the film will have a support layer, a cover layer and an adhesive layer. This adhesive is activated in the manner of a pressure-sensitive layer during the pressing onto the support structure of the vehicle component. In a further alternative form, the film may have a coating and a support layer. Just before the application to the support structure, an adhesive is applied to the side of the support layer situated opposite the coating. This is particularly a reactive hot-melt adhesive with a reaction time of from 6 to 8 h. The film has to be connected with the support structure within this time period, after which the adhesive hardens. A separation of the film and the support structure will then still be possible only by destroying the adhesive layer. During the manufacturing of the film, the support layer is produced first and is subsequently painted or coated with the coating material.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a cross-sectional view of a vehicle component according to an embodiment of the invention.

### DETAILED DESCRIPTION OF THE DRAWINGS

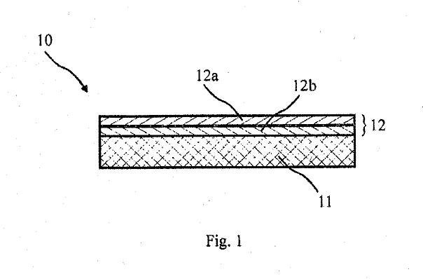

Referring to FIG. 1, the component 10 has a support structure 11, which may be constructed of a fiber-reinforced plastic, a thermoplastic synthetic material or a metallic material. The support structure 11 corresponds to an outer skin component of a motor vehicle, for example, a roof, a door, a bumper, etc. A film 12 is applied to a surface of the support structure 11 oriented toward the exterior side of the vehicle. The film 12 includes a support layer 12b and a coating 12a. The film 12 is glued to the support structure 11 by use of an adhesive. The film 12 may be provided with a color or be transparent or translucent. The film 12 may have a glossy surface, a mat surface or a combination of both.

As a result, a painting of vehicle components will not be necessary, and an energy-saving manufacturing process can thereby be created for automotive components. Furthermore, equipment investment costs for painting devices will be saved. The coating of automotive outer skin components offers a variety of design possibilities, the use of various colors, the placing of logos, pictures and the like, when the used films are colored, transparent or translucent, at least in sections. In comparison to painting processes, the expenditures are reduced to a minimum, whereby a series use of such coated vehicle components can be implemented.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A component of a motor vehicle, comprising:
an unpainted shaping support structure having at least one surface;
a film fastened to the at least one surface of the support structure via an adhesive, wherein
the film is a thermoformable film.

2. The component according to claim 1, wherein the component is an outer skin of the motor vehicle.

3. The component according to claim 1, wherein the film comprises at least a support layer and a coating layer.

4. The component according to claim 3, wherein the support layer of the film is, at least in sections, transparent, translucent and/or opaque.

5. The component according to claim 4, wherein the support layer comprises at least polycarbonate, a polycarbonate blend, polycarbonate copolymer, polyethylene terephthalate, polyethersulfone, acrylic ester styrol acrylonitrile, acrylic ester styrol acrylonitrile blend, thermoplastic polyurethane, polyolefin, polymethylmethacrylate and/or polyvinylidenefluoride.

6. The component according to claim 3, wherein the support layer comprises at least polycarbonate, a polycarbonate blend, polycarbonate copolymer, polyethylene terephthalate, polyethersulfone, acrylic ester styrol acrylonitrile, acrylic ester styrol acrylonitrile blend, thermoplastic polyurethane, polyolefin, polymethylmethacrylate and/or polyvinylidenefluoride.

7. The component according to claim 3, wherein the coating comprises aliphatic polyurethane.

8. The component according to claim 5, wherein the coating comprises aliphatic polyurethane.

9. The component according to claim 3, wherein the coating is a cross-linked coating that is cross-linked via short-wave radiation.

10. The component according to claim 9, wherein the shot-wave radiation is UV light.

11. The component according to claim 5, wherein the coating is a cross-linked coating that is cross-linked via short-wave radiation.

12. The component according to claim 1, wherein the support structure is made of a glass- or carbon-fiber-reinforced plastic material.

13. The component according to claim 1, wherein the support structure is made of iron plate, aluminum sheet, or a lightweight honeycomb structure.

14. A method of producing a component of a motor vehicle, the method comprising the acts of:
producing a support structure;
applying a thermoformed film to at least one surface of the support structure, the thermoformed film being constructed of several layers including a support layer and a coating layer;
gluing the film to the at least one surface of the support structure; and
after applying the thermoformed film to the at least one surface of the support structure, cross-linking the coating layer of the film.

15. The method according to claim 14, wherein the act of cross-linking the coating layer is carried out by irradiating the coating layer with short-wave radiation.

16. The method according to claim 15, wherein the short-wave radiation is UV light.

17. The method according to claim 14, wherein the thermoformed film is thermoformed prior to being applied to the at least one surface of the support structure.

18. The method according to claim 15, wherein the thermoformed film is thermoformed prior to being applied to the at least one surface of the support structure.

19. The method according to claim 14, wherein the vehicle component is an outer skin of the motor vehicle.

20. The method according to claim 19, wherein the support layer is, at least in sections, transparent, translucent and/or opaque.
